(19) United States
(12) Patent Application Publication
(10) Pub. No.: US 2007/0198711 A1
(43) Pub. Date: Aug. 23, 2007

(54) Apparatus and method for managing the viewing of images over an on-line computer network

(75) Inventor: Richard B. Maring, Hudsonville, MI (US)

Correspondence Address: THE WATSON INTELLECTUAL PROPERTY GROUP, PLC, 3133 HIGHLAND DRIVE, SUITE 200, HUDSONVILLE, MI, 49426, US

(73) Assignee: TRIBINIUM CORPORATION

(21) Appl. No.: 11/348,081

(22) Filed: Feb. 6, 2006

(51) Int. Cl. G06F 15/173

(52) U.S. Cl. 709/225

(57) ABSTRACT

A processor implemented method for managing the viewing of images by a user comprising the steps of (a) providing a listing of at least one of acceptable images and unacceptable images; (b) receiving a request by a user for content from an address on the Internet; (c) obtaining the content for the user, the content including at least one image; (d) determining if the at least one image is at least one of an unacceptable image and not an acceptable image; (e) replacing the image with a substitute image if the image is at least one of unacceptable image and not an acceptable image; and (f) providing the content to the user with the image replaced by the substitute image.

### BACKGROUND OF THE INVENTION

1. Field of the Invention

The invention relates in general to an apparatus and method for managing the viewing of visual content, and more particularly to a system and method for controlling and selectively precluding the viewing of certain visual content delivered to a computer over an on-line computer network (i.e., the Internet). While not limited thereto, the invention may be utilized to block unacceptable content, such as pornography, from being received and viewed by a user on a local computer.

2. Background Art

The Internet has become an indispensable tool used by students, teachers, professionals, consumers, sellers, etc. Amongst other businesses, the Internet has become a primary sales vehicle for the pornographic industry. Indeed, the number of websites which offer pornographic content is increasing at an exponential rate. It has been estimated that there are over 2500 new websites directed to pornography which are added on a daily basis. A quarter of all searches on Internet search engines (such as Google, Yahoo, Dogpile, etc.) are directed to pornography.

The appearance and the extent to which pornographic material has infiltrated the Internet makes it quite easy to, if desired, locate and view pornographic images. Moreover, it is quite easy to erroneously receive pornographic or otherwise unacceptable content from, for example, a simple spelling mistake in a website address, or the attachment of the wrong extension (.com instead of .gov, for example). Such an erroneous receipt of pornographic material is especially detrimental to children and young adults that are the most vulnerable.

There are certain software and hardware solutions which are designed to block content that is pornographic or otherwise deemed unacceptable. One such solution is offered under the name “NetNanny.” The system maintains a listing/database of unacceptable web addresses (IP addresses) which have been determined to include pornographic or otherwise unacceptable content. If a user of such a system seeks a webpage from a “known” unacceptable IP address, the system blocks user access to the webpage, and, in turn, precludes viewing of the unacceptable content.

For the system to properly operate, an extensive location based database must be maintained pertaining to the IP addresses of sites having unacceptable content. The system constantly crawls (i.e., searches) the Internet to uncover sites having unacceptable content. Once found, the IP address corresponding to the unacceptable content is added to the database. Each time a user requests content from a website, the system compares the website location requested to the listing of unacceptable locations.

While such systems have met with some success, there have been drawbacks, which have ultimately limited the acceptability and the accuracy of the system. In particular, due to the relative ease at which domain names can be purchased and the vast and inexpensive accessibility of server space upon which to host domains, it is quite easy to set up new locations. Even with powerful search and analysis equipment, it is virtually impossible to keep up with the addition of new domain names. For example, when an unacceptable site is uncovered, the provider of the site can obtain ten new addresses (or locations) and mirror the same unacceptable content to the ten new addresses. While the content of the ten new sites is identical to the uncovered site, it may take days, weeks, months, or even years for the crawling software to uncover the new sites. Until the sites are discovered, the content is available and generally not blocked by the system. Most all location based systems suffer from the inability to review websites anywhere near the speed at which new sites can be added. It has been found that unacceptable content on millions of websites can be traced to only a few content creators (which transmit and place the same unacceptable content on the various sites).

Furthermore, such systems generally fully block access to particular IP addresses. As such, while there may be unacceptable visual content, there may be perfectly acceptable text and images on the same site. Such systems cannot parse or divide the content of a website and provide only the acceptable information and images.

It is an object of the present invention to determine unacceptability of images appearing on websites, block same, regardless of the location at which the content is stored.

It is another object of the present invention to preclude the viewing of visual images if they are determined to be other than acceptable.

It is another object of the present invention to search the Internet for images, create a digital signature for each image, and store the digital signature in a listing/database, for future comparison with images gathered from other sites.

It is another object of the invention to permit a user to selectively view images deemed other than acceptable upon direction from a user.

It is another object of the invention to provide a substitute image in place of an unacceptable image while providing remaining requested content of a requested website or webpage to a user.

It is another object of the invention to morph an unacceptable image such that it is less readily distinguishable, or not readily distinguishable when provided to the user in response to a request for content.

These objects as well as other objects of the present invention will become apparent in light of the present specification, claims, and drawings.

### SUMMARY OF THE INVENTION

The invention is, in one aspect, directed to a processor implemented method for managing the viewing of images by a user comprising the steps of (a) providing a listing of at least one of acceptable images and unacceptable images; (b) receiving a request by a user for content from an address on the Internet; (c) obtaining the content for the user, the content including at least one image; (d) determining if the at least one image is at least one of an unacceptable image and not an acceptable image; (e) replacing the image with a substitute image if the image is at least one of unacceptable image and not an acceptable image; and (f) providing the content to the user with the image replaced by the substitute image.

In a preferred embodiment, the method comprises the steps of receiving a request from the user for the at least one image; and replacing the substitute image with the at least one image.

In one such preferred embodiment, the method further comprises the steps of receiving an indication from the user that the at least one image is one of an unacceptable image and an acceptable image; and adding the at least one image to the listing.

In another such preferred embodiment, the step of providing comprises the step of generating a listing of at least one of acceptable and unacceptable images.

In one such embodiment, the step of generating a listing comprises the steps of (a) sequentially locating webpages; (b) obtaining content from each webpage; (c) identifying any acceptable images on the website; (d) computing a digital signature of each of the acceptable images; and (e) adding the digital signature of the acceptable image to a database listing of acceptable images.

In one such embodiment, the method further comprises the steps of identifying any unacceptable images on the website; computing a digital signature of each of the unacceptable images; and adding the digital signature of the unacceptable image to a database listing of unacceptable images.

In another such embodiment, the step of generating is carried out simultaneously on a plurality of computers wherein the user has allowed such generating when the computer is otherwise not in use.

In yet another embodiment, the step of replacing comprises the steps of morphing the image through a predetermined algorithm to obtain an less visually discernable image; and repeating the step of morphing until the image is no longer adequately visually discernable.

In a preferred embodiment, the method further comprises the step of receiving a request from the user to reverse one or more repetitions of the step of morphing so as to increase the visual discernability of the image.

In another embodiment, the step of providing a listing further comprises the step of providing the listing of each of acceptable images and unacceptable images.

In yet another embodiment, the step of providing a listing further comprises the step of: categorizing the unacceptable images into any one of a plurality of categories based upon at least one criteria associated with unacceptability; allowing the user to set a level of unacceptability corresponding to one of the plurality of categories; and replacing the images of unacceptable images corresponding to categories which are the same as or greater than the level of unacceptability selected by the user.

In a preferred embodiment, the method comprises the steps of receiving a request from the user to cease replacing the image with a substitute image; and stopping the operation of the method.

In another preferred embodiment, the method comprises the steps of receiving a request from a user to determine if an image corresponding to the substitute image comprises an acceptable image; reviewing the image to determine if the image is acceptable or unacceptable; and adding the image to the listing of either one of acceptable images and unacceptable images.

In another aspect of the invention, the invention comprises an apparatus for managing the viewing of images by a user comprising a listing of at least one of acceptable images and unacceptable images, request receiving means, content obtaining means, determining means, replacing means and content providing means. The receiving means receives a request by a user for content from an address on the Internet. The obtaining means obtains the content for the user, the content including at least one image. The determining means determines if the at least one image is at least one of an unacceptable image and not an acceptable image. The replacing means replaces the image with a substitute image if the image is at least one of unacceptable image and not an acceptable image. The providing means provides the content to the user with the image replaced by the substitute image.

In one such preferred embodiment, the apparatus further includes receiving means and adding means. The receiving means receives an indication from the user that the at least one image is one of an unacceptable image and an acceptable image. The adding means adds the at least one image to the listing.

In another preferred embodiment, the replacing means further comprises means for repeatedly morphing the image through a predetermined algorithm to obtain an less visually discernable image.

In one such preferred embodiment, the replacing means further comprises means for reversing the repeated morphing means to return the less visually discernable image to the image.

In yet another aspect of the invention, the invention comprises an apparatus for generating a listing of acceptable images and unacceptable images. The apparatus comprises means for sequentially locating webpages, means for obtaining content from each webpage, means for identifying any acceptable images on the website, means for computing a digital signature of each of the acceptable images, and, means for adding the digital signature of the acceptable image to a database listing of acceptable images.

In one embodiment, the apparatus further comprises means for identifying any unacceptable images on the website, means for computing a digital signature of each of the unacceptable images, and, means for adding the digital signature of the unacceptable image to a database listing of unacceptable images.

In yet another aspect of the invention, the invention comprises an article of manufacture for managing the viewing of images by a user. The article of manufacture includes a computer-readable medium configured with instructions for causing a processor-based system to perform the steps of (a) providing a listing of at least one of acceptable images and unacceptable images; (b) receiving a request by a user for content from an address on the Internet; (c) obtaining the content for the user, the content including at least one image; (d) determining if the at least one image is at least one of an unacceptable image and not an acceptable image; (e) replacing the image with a substitute image if the image is at least one of unacceptable image and not an acceptable image; and (f) providing the content to the user with the image replaced by the substitute image.

In a preferred embodiment, the article of manufacture is further configured with instructions for causing a processor-based system to perform the steps of morphing the image through a predetermined algorithm to obtain an less visually discernable image; and repeating the step of morphing until the image is no longer adequately visually discernable.

In another preferred embodiment the article of manufacture is further configured with instructions for causing a processor-based system to perform the step of receiving a request from the user to reverse one or more repetitions of the step of morphing so as to increase the visual discernability of the image.

### BRIEF DESCRIPTION OF THE DRAWINGS

The invention will now be described with reference to the drawings wherein:

FIG. 1 of the drawings comprises a schematic representation of a on-line computer network, showing, in particular, the Internet, an exemplary ISP, an exemplary LAN, an exemplary computer attached to the exemplary LAN, and an exemplary computer attached to the ISP;

FIG. 2 of the drawings comprises a flowchart of one aspect of the present invention, showing in particular, the operation of the system in response to a request for content from a user;

FIG. 3 of the drawings comprises a flowchart of another aspect of the present invention, showing in particular, the operation of the system in response to the request to un-modify or unmorph content that has been determined to be other than acceptable;

FIG. 4 of the drawings comprises flowchart of another aspect of the present invention, showing, in particular, the operation of the system with respect to forming a listing of acceptable and unacceptable images; and

FIG. 5 of the drawings comprises a browser window, showing, in particular, a drop-down menu having user actuatable requests relative to content that has been modified and/or morphed.

### DETAILED DESCRIPTION OF THE DRAWINGS

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

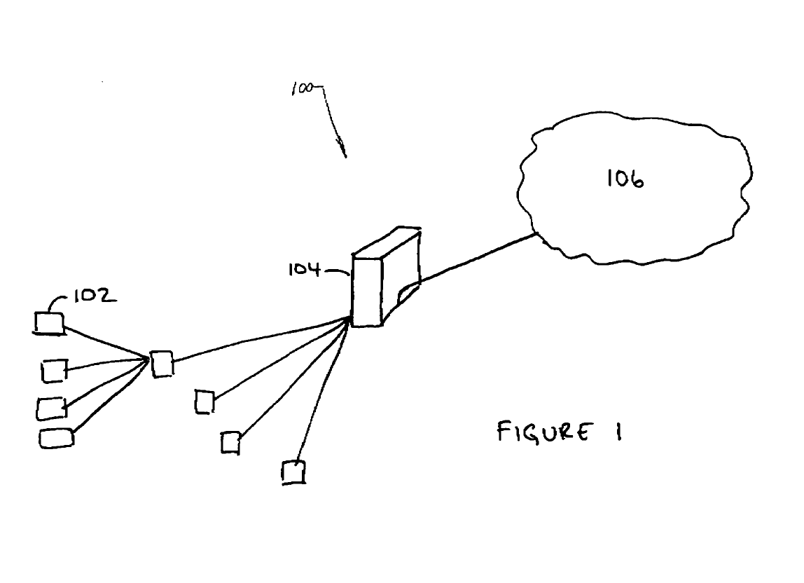

Referring now to the drawings and in particular to FIG. 1, the system is configured to operate in association with an on-line network of computers represented at 100. In a typical situation, a local computer 102 may be part of a local area network (LAN). The LAN is coupled to an Internet Service Provider (ISP) 104 for access to the Internet 106. As the user seeks content from the internet, the user identifies the particular website (through a URL or an IP address xxx.xxx.xxx.xxx). The query is sent to ISP 104 which seeks that address on Internet 106. When the content is located, the content is downloaded to ISP 104 and, subsequently, to local computer 102. With websites having heavy traffic from ISP 104, ISP 104 may maintain a copy of the content of the website such that every time a computer associated with ISP 104 requests the content, ISP 104 can provide the content from its own cache, rather than seeking the information from Internet 106 each time.

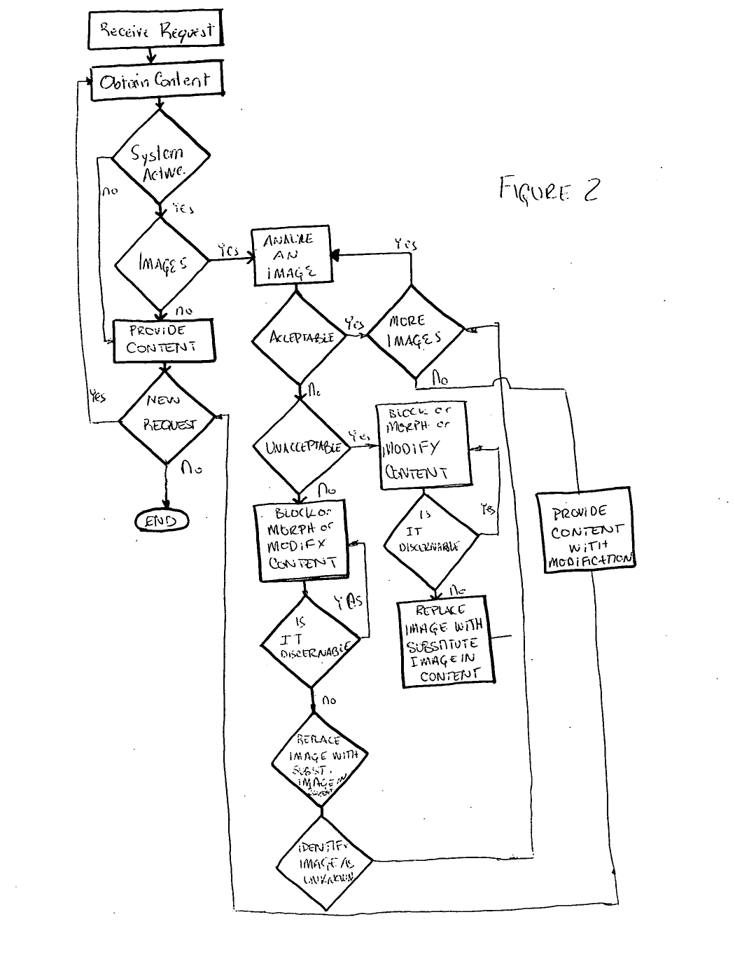

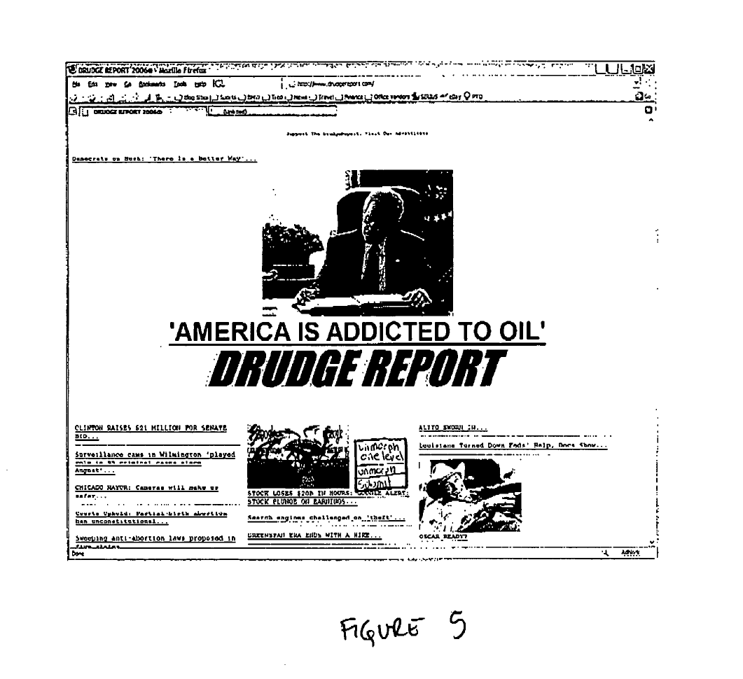

It is contemplated that the present apparatus is operated at the level of ISP 104, however, it may be implemented at other locations, such as between the ISP and the Internet, or between the ISP and the local computer. The apparatus may comprise software which is maintained and operated in a server or other computer coupled to ISP 104. The operation of the apparatus is explained with reference to FIGS. 2 through 5.

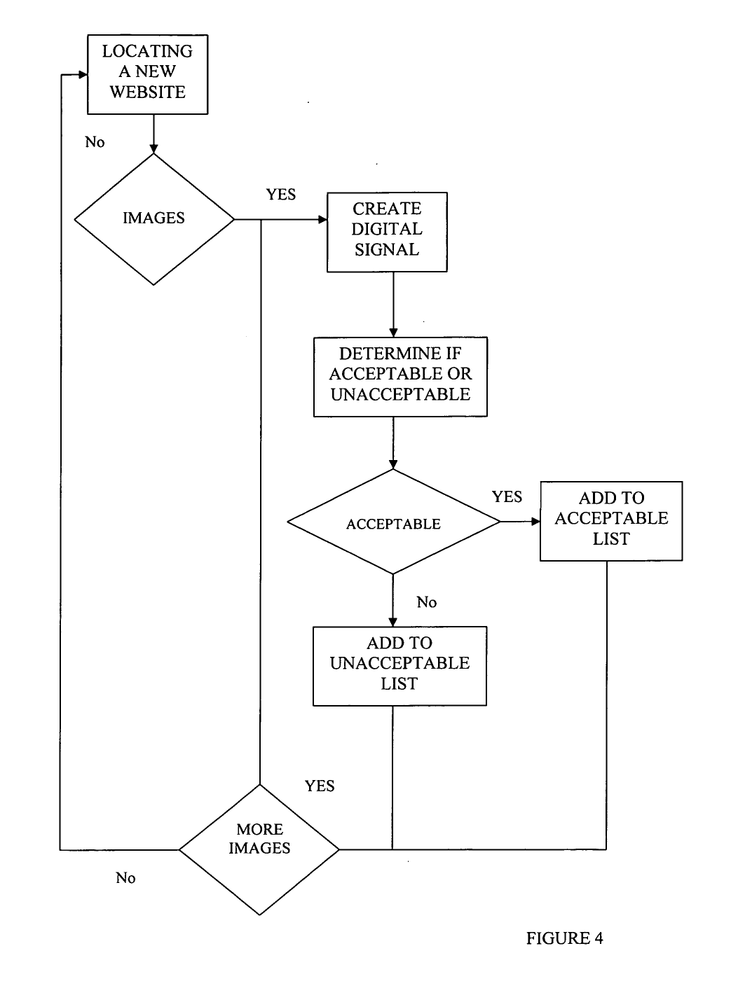

In particular, and with reference to FIG. 4, the system crawls through Internet 106 to locate websites and then to analyze websites to determine the visual content of the websites and to then determine as to whether the content is acceptable or unacceptable. The step of crawling is well known in the art, wherein web robots, web crawlers an/or BOTS are employed to systematically crawl through the internet to categorize, review and analyze same. To focus or further direct initial implementation, listings of pornographic or otherwise unacceptable websites, existing websites, known acceptable websites can be obtained from a number of different providers. These websites can be crawled first prior to general crawling of other websites.

At each website, each visual image is found, provided with an identification and categorized. It will be understood that each webpage may include any number of visual images. Such images may be in any one of a number of formats, JPEG, GIF, TIFF, RAW, PNG, PIZ. With respect to each visual image, upon identification, the image is processed through an algorithm which prepares an identification code for the image. One type of identification contemplated, processes the visual image file through a SHA-1 Hash Code. Such a code is utilized by the Government to identify the authenticity of documents. It is often contemplated that the system is of such accuracy that there is a 1 in 1¹²⁸ of a false positive. Such a coding system is highly reliable and yields a substantially unique digital signature to each visual image.

The digital signature in such a system comprises a 160 character “fingerprint” of the document. Of course, in other embodiments, other identification systems can be utilized which creates an alternate digital identification of the visual image.

Either before or after the creation of the digital signature from the visual image file, the visual image is determined to be acceptable or unacceptable. If the visual image is unacceptable, the system can further determine a level of unacceptability if desired. For example, certain images may be deemed mildly unacceptable, substantially unacceptable, unacceptable, highly unacceptable. The number of categories and the details relative to categorization can be determined based upon a number of criteria (social acceptability in a particular country, a particular religion, etc.). The initial determination and subsequent optional categorization can be done manually, through Heuristic Text Weighting processes, Neural Networks, and/or artificial intelligence networks for image recognition and automated image or content classification. Indeed the system is not limited to any particular classification methodology. It will be understood that with as much content as is available on Internet 106, automation is highly desirable and virtually indispensable. Of course, it will be understood that if unacceptable websites are known, all of the images processed from the website can be deemed unacceptable.

A database (or listing) is configured to store the digital signature of each image coupled with an identification as to acceptability or unacceptability. Additionally, the database can be configured to include a categorization of the level of unacceptability. The database can be replicated at each ISP 104 and updated on a regular basis. In other embodiments, it is contemplated that the database may likewise be available at a number of locations on Internet 106.

It will be understood that in the preferred embodiment, the system stores a digital signature for both acceptable images and unacceptable images. Indeed, three different groups of images are created. First, a number of images will have been categorized as acceptable. Second, a number a images will be have been categorized as unacceptable. Third, a number of images have yet to be reviewed or classified by the system, and, in turn, no such categorization for these images exists.

To develop the database, a number of servers can be dedicated for crawling. In addition, remote computers can be utilized for crawling and identification. For example, users can sign up to permit software to be loaded onto their computers wherein the software can be activated to undertake the crawling and categorization when not in use by the user. Such a system has been implemented under the name SETI@Home, utilizing an open source code commonly referred to as BOINC. In particular, a user voluntarily allows software to be placed onto his or her local computer. The software is activated when the computer is otherwise idle to process data which is gathered in an effort to seek extraterrestrial life. As the user needs the computer, the program stops. Thus, the software can utilize the computing power of numerous computers when they would otherwise be in an idle state.

Once a reasonably sized database is created, the system can be implemented. As set forth above, it is advantageous to have the system operate at ISP 104. With reference to FIG. 2, as the user requests a website, the request is transmitted to ISP 104. ISP 104 checks to see if the requested content is available on its own cache or if it must go to Internet 106 to obtain the requested content. In either case, ISP 104 obtains the content. Once obtained, the content is examined for visual images. Each visual image is reviewed and a digital signature of each visual image is created. Next, each digital signature is compared to the digital signatures contained in the database of digital signatures. One of three results are possible. First, digital signature may be identified as corresponding to an acceptable image. Second, the digital signature may be identified as corresponding to an unacceptable image. Third, the digital signature may be unrecognized. This procedure is repeated for each image.

For images that have digital signatures corresponding to identified acceptable images, the images are identified as acceptable, and passed to the user without modification. On the other hand, images that are known to be unacceptable can be either blocked from the user entirely, or modified so as to be visually less discernable. For example, algorithms exist which “cloak” an image. Certain of the algorithms take a sampling of pixels of an image and set adjoining pixels to the same color as the sampled pixels. As the algorithm is repeated, the original image is morphed into a substantially less discernable image. The same procedure can be taken with respect to images that correspond to digital signatures that are not in the database. In such an embodiment, there is no fear that an unknown image will be transmitted; rather, the unknown image is either blocked or modified.

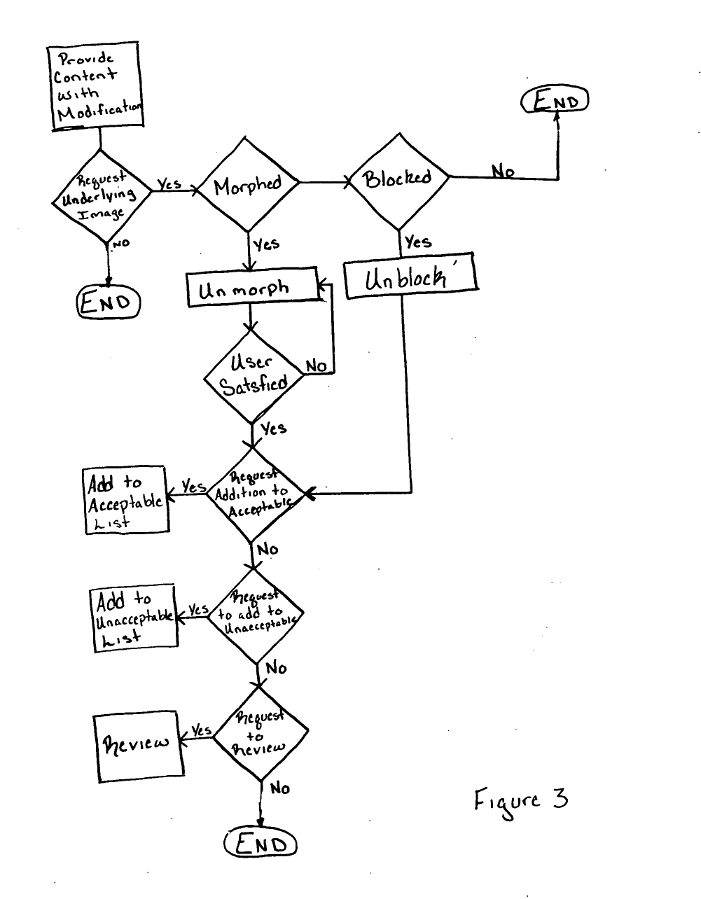

When the user receives the webpage, images that are deemed acceptable appear without modification. Unacceptable and unknown images either do not appear or appear in a morphed or modified condition. There can additionally be an identification to the user as to whether the image is known to the database, and, in turn, unacceptable, or unknown. As is shown in FIG. 3, in the event that it is unknown, the user can reverse the morphing process to return the image to its original appearance. Inasmuch as the morphing process may be carried out through steps, the reversing can likewise be done in steps such that after each step, the image becomes more readily discernable. The user may be able to make a determination as to acceptability without reversing the morphing process entirely. Once the image is discerned, the user can submit a suggestion to add the image to the database as either one of an acceptable image or an unacceptable image. These user added images can be reviewed to preclude the inadvertent or mistaken addition of unacceptable images to the database as acceptable images. In another embodiment, the user can request that the image be processed by the system without viewing or reversing the morphing process.

It is contemplated that a user can instruct the system to cease determining the acceptability of images, and, instead to allow all content to reach the user without modification. The instruction can pertain to the particular browser session or a particular time period. The system can be configured to default to various levels of protection based upon the user that is logged into computer 102. In the embodiment wherein unacceptable content can be categorized, a user can set a user defined category level. Furthermore, any overriding of the system can be password protected.

The software to provide the functionality to the user can be downloaded by the user from Internet 106 or from ISP 104. The functionality can be presented to the user in the form of additional features that are added to the menu's across the top of the browser window. In other embodiments, a toolbar can be installed as a browser add-on on computer 102. In other embodiments, features can be added to the menu accessed through a right click on a mouse. Indeed, the invention is not limited to any particular software implementation.

In certain embodiments, it is contemplated that the system can work in conjunction with systems which block webpages based on location. For example, if a website is known to include unacceptable content based upon the location of the website, access to the website can be fully blocked.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A processor implemented method for managing the viewing of images by a user comprising the steps of:
providing a listing of at least one of acceptable images and unacceptable images;
receiving a request by a user for content from an address on the Internet;
obtaining the content for the user, the content including at least one image;
determining if the at least one image is at least one of an unacceptable image and not an acceptable image;
replacing the image with a substitute image if the image is at least one of unacceptable image and not an acceptable image; and
providing the content to the user with the image replaced by the substitute image.

2. The method of claim 1 further comprising the steps of:
receiving a request from the user for the at least one image; and
replacing the substitute image with the at least one image.

3. The method of claim 2 wherein further comprising the steps of:
receiving an indication from the user that the at least one image is one of an unacceptable image and an acceptable image; and
adding the at least one image to the listing.

4. The method of claim 2 wherein the step of providing comprises the step of generating a listing of at least one of acceptable and unacceptable images.

5. The method of claim 4 wherein the step of generating a listing comprises the steps of:
sequentially locating webpages;
obtaining content from each webpage;
identifying any acceptable images on the website;
computing a digital signature of each of the acceptable images; and
adding the digital signature of the acceptable image to a database listing of acceptable images.

6. The method of claim 5 further comprising the steps of:
identifying any unacceptable images on the website;
computing a digital signature of each of the unacceptable images; and
adding the digital signature of the unacceptable image to a database listing of unacceptable images.

7. The method of claim 4 wherein the step of generating is carried out simultaneously on a plurality of computers wherein the user has allowed such generating when the computer is otherwise not in use.

8. The method of claim 1 wherein the step of replacing comprises the steps of:
morphing the image through a predetermined algorithm to obtain an less visually discernable image; and
repeating the step of morphing until the image is no longer adequately visually discernable.

9. The method of claim 8 further comprising the step of:
receiving a request from the user to reverse one or more repetitions of the step of morphing so as to increase the visual discernability of the image.

10. The method of claim 1 wherein the step of providing a listing further comprises the step of providing the listing of each of acceptable images and unacceptable images.

11. The method of claim 1 wherein the step of providing a listing further comprises the steps of:
categorizing the unacceptable images into any one of a plurality of categories based upon at least one criteria associated with unacceptability;
allowing the user to set a level of unacceptability corresponding to one of the plurality of categories; and
replacing the images of unacceptable images corresponding to categories which are the same as or greater than the level of unacceptability selected by the user.

12. The method of claim 1 further comprising the steps of:
receiving a request from the user to cease replacing the image with a substitute image; and
stopping the operation of the method.

13. The method of claim 1 further comprising the steps of:
receiving a request from a user to determine if an image corresponding to the substitute image comprises an acceptable image;
reviewing the image to determine if the image is acceptable or unacceptable; and
adding the image to the listing of either one of acceptable images and unacceptable images.

14. An apparatus for managing the viewing of images by a user comprising:
a listing of at least one of acceptable images and unacceptable images;
means for receiving a request by a user for content from an address on the Internet;
means for obtaining the content for the user, the content including at least one image;
means for determining if the at least one image is at least one of an unacceptable image and not an acceptable image;
means for replacing the image with a substitute image if the image is at least one of unacceptable image and not an acceptable image; and
means for providing the content to the user with the image replaced by the substitute image.

15. The apparatus of claim 14 further comprising:
means for receiving an indication from the user that the at least one image is one of an unacceptable image and an acceptable image; and
means for adding the at least one image to the listing.

16. The apparatus of claim 14 wherein the replacing means further comprises:
means for repeatedly morphing the image through a predetermined algorithm to obtain an less visually discernable image.

17. The apparatus of claim 16 wherein the replacing means further comprises:
means for reversing the repeated morphing means to return the less visually discernable image to the image.

18. An apparatus for generating a listing of acceptable images and unacceptable images comprising:
means for sequentially locating webpages;
means for obtaining content from each webpage;
means for identifying any acceptable images on the website;
means for computing a digital signature of each of the acceptable images; and
means for adding the digital signature of the acceptable image to a database listing of acceptable images.

19. The apparatus of claim 18 further comprising:
means for identifying any unacceptable images on the website;
means for computing a digital signature of each of the unacceptable images; and
means for adding the digital signature of the unacceptable image to a database listing of unacceptable images.

20. An article of manufacture for managing the viewing of images by a user comprising:
A computer-readable medium configured with instructions for causing a processor-based system to perform the steps of:
providing a listing of at least one of acceptable images and unacceptable images;
receiving a request by a user for content from an address on the Internet;
obtaining the content for the user, the content including at least one image;
determining if the at least one image is at least one of an unacceptable image and not an acceptable image;
replacing the image with a substitute image if the image is at least one of unacceptable image and not an acceptable image; and
providing the content to the user with the image replaced by the substitute image.

21. The article of manufacture of claim 20 further configured with instructions for causing a processor-based system to perform the steps of:
morphing the image through a predetermined algorithm to obtain an less visually discernable image; and
repeating the step of morphing until the image is no longer adequately visually discernable.

22. The article of manufacture of claim 21 further configured with instructions for causing a processor-based system to perform the steps of:
receiving a request from the user to reverse one or more repetitions of the step of morphing so as to increase the visual discernability of the image.
